(19) United States
(12) Patent Application Publication
(10) Pub. No.: US 2025/0007209 A1
(43) Pub. Date: Jan. 2, 2025

(54) CONNECTOR ASSEMBLY

(71) Applicant: Japan Aviation Electronics Industry, Limited, Tokyo (JP)

(72) Inventor: Akira KIMURA, Tokyo (JP)

(21) Appl. No.: 18/673,745

(22) Filed: May 24, 2024

(30) Foreign Application Priority Data
Jun. 28, 2023 (JP) 2023-105825

(51) Int. Cl. H01R 13/62; H01R 13/11

(52) U.S. Cl. CPC H01R 13/6205; H01R 13/111

(57) ABSTRACT

A connector assembly includes a first connector and a second connector fitted together along a fitting direction, the first connector having a conductive first contact with a first contact portion and a first retention member joined to the first contact, the second connector having a second insulator, a conductive second contact with a second contact portion retained by the second insulator, and a second retention member retained by the second insulator attracted to the first retention member by a magnetic force, one of the first contact portion and the second contact portion having a flat shape extending in a predetermined direction perpendicular to the fitting direction, one of the first retention member and the second retention member having a lock portion and the other having a lock receiving portion.

### BACKGROUND OF THE INVENTION

The present invention relates to a connector assembly, particularly to a connector assembly in which a first connector and a second connector are fitted together by use of a magnetic force.

A connector assembly serving to maintain a fitted state using the magnetic force is disclosed in, for instance, JP 2020-30906 A. The connector assembly includes a first connector 1 sewn and fixed to clothes or the like and a second connector 2 to be fitted to the first connector 1 as shown in FIG. 35.

The second connector 2 includes: a plurality of second contacts 3 disposed on a surface, facing the first connector 1, of the second connector 2 and each constituted of a so-called pogo pin; and two yokes 4 of plate shape attached to a magnet installed inside the second connector 2 and partially exposed on the surface, facing the first connector 1, of the second connector 2.

The first connector 1 includes a plate-shaped housing 5, and the housing 5 is provided, on its surface facing the second connector 2, with a plurality of first contacts 6 and a plurality of retention members 7 made of magnetic metal or magnet as shown in FIG. 36.

When the second connector 2 is fitted to the first connector 1, the retention members 7 of the first connector 1 are attracted to the two yokes 4 of the second connector 2 by the magnetic force, and the second contacts 3 of the second connector 2 elastically make contact with the first contacts 6 of the first connector 1, whereby the first contacts 6 are electrically connected to the second contacts 3.

In the connector assembly of JP 2020-30906 A, while the first connector 1 and the second connector 2 can be easily brought into a fitted state by use of the magnetic force, an elastic force acting from the second contacts 3 to the first contacts 6 is directed so as to separate the second connector 2 from the first connector 1. Accordingly, when a gap is generated between the retention members 7 and the yokes 4 due to an external force such as impact or other reasons, the contact between the first contacts 6 and the second contacts 3 may be destabilized, and this may lower the reliability of electric connection or impair the fitted state between the first connector 1 and the second connector 2.

Besides, in the case where dirt or foreign matter is attached to a surface of at least one of the first contacts 6 or the second contacts 3, when the second contacts 3 elastically make contact with the first contacts 6 at fitting, the dirt or foreign matter is pressed between the relevant first and second contacts 6 and 3, and this may cause poor contact, resulting in lower reliability of electric connection.

### SUMMARY OF THE INVENTION

The present invention has been made to solve the foregoing conventional problems and aims at providing a connector assembly capable of improving the reliability of electric connection while easily establishing the fitted state between a first connector and a second connector. A connector assembly according to the present invention is one in which a first connector and a second connector are fitted together along a fitting direction,
the first connector includes:
   a first contact having electrical conductivity and having a first contact portion; and
   a first retention member joined to the first contact, and
the second connector includes:
   a second insulator;
   a second contact having electrical conductivity, retained by the second insulator, and having a second contact portion that faces the first contact portion of the first contact along the fitting direction; and
   a second retention member retained by the second insulator, the second retention member attracting and being attracted to the first retention member by a magnetic force,
wherein one of the first contact portion and the second contact portion has a flat shape extending in a predetermined direction perpendicular to the fitting direction,
one of the first retention member and the second retention member has a lock portion, and the other thereof has a lock receiving portion into which the lock portion is fitted from the predetermined direction,
when the second connector is relatively moved to a predetermined fitting start position with respect to the first connector along the fitting direction, the second retention member is attracted to the first retention member along the fitting direction, and the second contact portion makes contact with the first contact portion, whereby the second contact is electrically connected to the first contact, and
when the second connector is relatively slid from the predetermined fitting start position to a predetermined fitting completed position with respect to the first connector along the predetermined direction, the second contact portion is relatively slid with respect to the first contact portion in the predetermined direction while maintaining contact with the first contact portion, and the lock portion is fitted into the lock receiving portion, whereby the second connector is fitted to the first connector.

### BRIEF DESCRIPTION OF THE DRAWINGS

FIG. 1 is a perspective view showing a non-fitted state between a first connector and a second connector of a connector assembly according to Embodiment 1.

FIG. 2 is an assembly view of the first connector in Embodiment 1.

FIG. 3 is a perspective view showing a first contact used in the first connector in Embodiment 1.

FIG. 4 is a perspective view showing a first retention member used in the first connector in Embodiment 1.

FIG. 5 is a perspective view showing a first insulator used in the first connector in Embodiment 1.

FIG. 6 is a partial cross-sectional view showing the first connector in Embodiment 1.

FIG. 7 is an assembly view of the second connector in Embodiment 1.

FIG. 8 is a perspective view showing a second contact used in the second connector in Embodiment 1.

FIG. 9 is a perspective view showing a magnet of a second retention member used in the second connector in Embodiment 1.

FIG. 10 is a perspective view showing a retention plate of the second retention member used in the second connector in Embodiment 1.

FIG. 11 is a perspective view showing the second retention member used in the second connector in Embodiment 1.

FIG. 12 is a perspective view showing the second connector in Embodiment 1 when viewed from an obliquely lower position.

FIG. 13 is a partial cross-sectional view showing the second connector in Embodiment 1.

FIG. 14 is a partial cross-sectional view showing the first connector and the second connector that are aligned with respect to each other in the connector assembly according to Embodiment 1.

FIG. 15 is a partial cross-sectional view showing the second connector being in a fitting start position with respect to the first connector in the connector assembly according to Embodiment 1.

FIG. 16 is a cross-sectional view taken along line A-A in FIG. 15.

FIG. 17 is a partial cross-sectional view taken along line B-B in FIG. 16.

FIG. 18 is a partial cross-sectional view showing the second connector being in a fitting completed position with respect to the first connector in the connector assembly according to Embodiment 1.

FIG. 19 is a cross-sectional view taken along line C-C in FIG. 18.

FIG. 20 is a partial cross-sectional view taken along line D-D in FIG. 19.

FIG. 21 is a perspective view showing a fitted state between the first connector and the second connector of the connector assembly according to Embodiment 1.

FIG. 22 is a bottom view of the second connector in the process of production of the connector assembly according to Embodiment 1.

FIG. 23 is a perspective view showing a non-fitted state between a first connector and a second connector of a connector assembly according to Embodiment 2.

FIG. 24 is an assembly view of the second connector in Embodiment 2.

FIG. 25 is a perspective view showing a magnet of a second retention member used in the second connector in Embodiment 2.

FIG. 26 is a perspective view showing a retention plate of the second retention member used in the second connector in Embodiment 2.

FIG. 27 is a partial cross-sectional view showing the second connector in Embodiment 2.

FIG. 28 is a partial bottom view showing the second connector in Embodiment 2.

FIG. 29 is a partial cross-sectional view showing the first connector and the second connector that are aligned with respect to each other in the connector assembly according to Embodiment 2.

FIG. 30 is a partial cross-sectional view showing the second connector being in a fitting start position with respect to the first connector in the connector assembly according to Embodiment 2.

FIG. 31 is a cross-sectional view taken along line E-E in FIG. 30.

FIG. 32 is a partial cross-sectional view showing the second connector being in a fitting completed position with respect to the first connector in the connector assembly according to Embodiment 2.

FIG. 33 is a cross-sectional view taken along line F-F in FIG. 32.

FIG. 34 is a bottom view of the second connector in the process of production of the connector assembly according to Embodiment 2.

FIG. 35 is a perspective view showing a non-fitted state between a first connector and a second connector in a conventional connector.

FIG. 36 is a perspective view of the first connector in the conventional connector when viewed from an obliquely lower position.

### DETAILED DESCRIPTION OF THE INVENTION

Embodiments of the present invention are described below based on the accompanying drawings.

### Embodiment 1

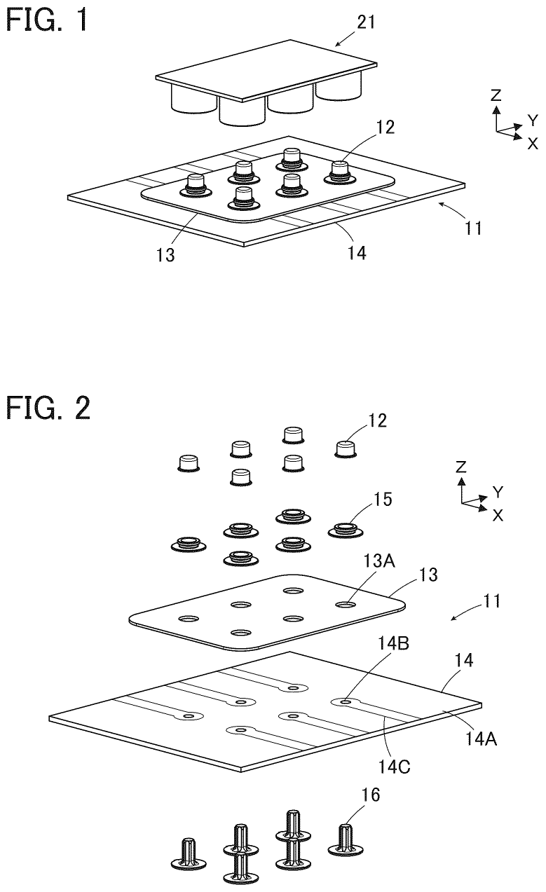

FIG. 1 shows a connector assembly according to Embodiment 1. The connector assembly includes a first connector 11 and a second connector 21 to be fitted to the first connector 11 along a fitting direction.

The first connector 11 is used as, for example, a garment-side connector for connecting a wearable device and includes six first contacts 12 protruding toward the second connector 21. The six first contacts 12 are aligned in two rows and attached to a sheet type conductive member 14 via a reinforcement sheet 13.

For convenience, the reinforcement sheet 13 and the sheet type conductive member 14 are defined as extending along an XY plane, the direction in which the first contacts 12 are aligned in two rows is referred to as “Y direction,” and the direction from the first connector 11 toward the second connector 21 is referred to as “+Z direction.” The Z direction is the fitting direction in which the first connector 11 and the second connector 21 are fitted together.

FIG. 2 shows an assembly view of the first connector 11. Six first retention members 15 are disposed on the −Z direction side of the six first contacts 12, the reinforcement sheet 13 and the sheet type conductive member 14 are sequentially disposed on the −Z direction side of the six first retention members 15, and six first insulators 16 are disposed on the −Z direction side of the sheet type conductive member 14.

The sheet type conductive member 14 includes an insulating sheet body 14A, six through-holes 14B formed in the sheet body 14A and corresponding to the six first contacts 12, and six flexible conductors 14C exposed around the corresponding through-holes 14B at least on the surface of the sheet body 14A on the +Z direction side. As the sheet body 14A, for example, cloth or knitted fabric of a garment may be used, and the flexible conductors 14C can be formed by embroidering the sheet body 14A with an embroidery thread constituted of a conductive thread.

The reinforcement sheet 13 is used to reinforce the sheet body 14A of the sheet type conductive member 14 on which the first connector 11 is mounted. The reinforcement sheet 13 is made of an insulating material and has six through-holes 13A corresponding to the six first contacts 12.

The sheet type conductive member 14 and the reinforcement sheet 13 have flexibility.

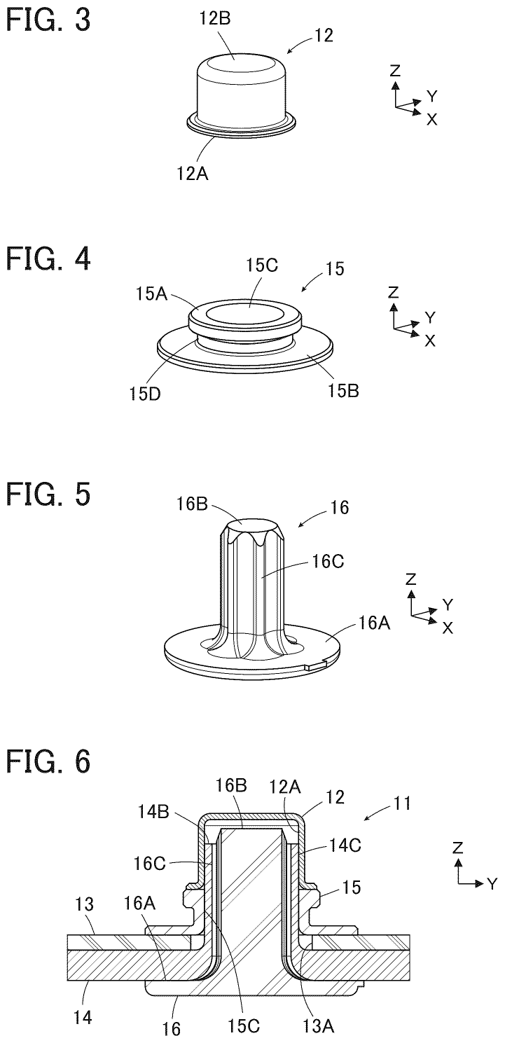

As shown in FIG. 3, the first contact 12 is formed of an electrically conductive material such as metal, has a tubular shape, specifically a cylindrical shape, extending in the Z direction, and is provided in its inside with a recess portion 12A opening in the −Z direction. The first contact 12 is provided at its upper portion with a first contact portion 12B having a circular flat shape extending along an XY plane and facing in the +Z direction.

As shown in FIG. 4, the first retention member 15 is formed of a magnetic body and includes a tubular portion 15A extending in the Z direction and a flange 15B extending out of the tubular portion 15A from the −Z directional end of the tubular portion 15A along an XY plane. The tubular portion 15A is provided with a through-hole 15C penetrating the first retention member 15 in the Z direction. The through-hole 15C has an inner diameter substantially the same as the inner diameter of the recess portion 12A of the first contact 12.

The −Z directional end of the tubular portion 15A in contact with the flange 15B is provided with an annular groove 15D along the outer periphery of the tubular portion 15A.

As shown in FIG. 5, the first insulator 16 is formed of, for instance, insulating resin and includes a base portion 16A of disc shape extending in an XY plane and a projection 16B projecting in the +Z direction from the center of the base portion 16A. The projection 16B is provided with a plurality of ribs 16C radially protruding and extending in the Z direction. The projection 16B is sized to be able to compress the sheet type conductive member 14 in the thickness direction of the sheet type conductive member 14 when being inserted into the through-hole 15C of the tubular portion 15A of the first retention member 15 and the recess portion 12A of the first contact 12 while pushing the sheet type conductive member 14 thereinto.

FIG. 6 shows a cross-sectional view corresponding to one first contact 12 of the first connector 11 that is assembled using the thus configured first contacts 12, first retention members 15, reinforcement sheet 13, sheet type conductive member 14, and first insulators 16.

The reinforcement sheet 13 is stacked on the sheet type conductive member 14 with the through-holes 14B and 13A being aligned, and the first retention member 15 and the first contact 12 are sequentially disposed in a coaxial manner on the reinforcement sheet 13 to be aligned with the through-hole 13A; in this state, the projection 16B of the first insulator 16 is pushed in the +Z direction from the −Z direction of the sheet type conductive member 14 through the through-hole 14B of the sheet type conductive member 14. The projection 16B is sequentially inserted into the through-hole 15C of the first retention member 15 and the recess portion 12A of the first contact 12 while pushing a part of the sheet type conductive member 14 situated around the through-hole 14B thereinto.

Consequently, the sheet type conductive member 14 is sandwiched between the rib 16C of the projection 16B and the inner surface of the through-hole 15C of the first retention member 15 and between the rib 16C of the projection 16B and the inner surface of the recess portion 12A of the first contact 12 and compressed in a direction along an XY plane. As a result, the flexible conductor 14C exposed on the surface of the sheet type conductive member 14 makes contact with the inner surface of the recess portion 12A at a predetermined contact pressure, whereby the first contact 12 is electrically connected to the flexible conductor 14C.

In addition, the first retention member 15 and the first contact 12 are joined together in the Z direction via the projection 16B of the first insulator 16 and the sheet type conductive member 14.

The base portion 16A of the first insulator 16 comes into contact with the rear surface, on the −Z direction side, of the sheet type conductive member 14.

The six first contacts 12 of the first connector 11 are all electrically connected to the corresponding flexible conductors 14C and also joined to the corresponding first retention members 15 by the connection structure illustrated in FIG. 6.

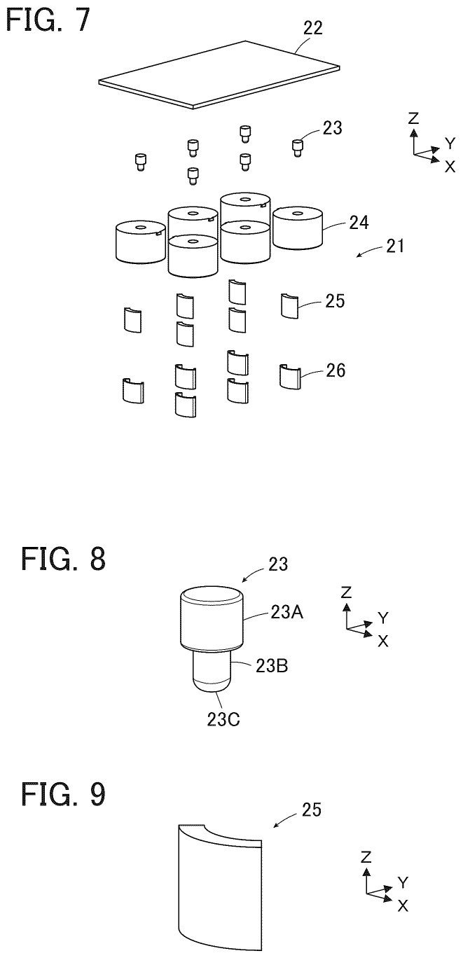

FIG. 7 shows an assembly view of the second connector 21. Six second contacts 23 are disposed on the −Z direction side of a substrate 22, six second insulators 24 are disposed on the −Z direction side of the six second contacts 23, six magnets 25 are disposed on the −Z direction side of the six second insulators 24, and six retention plates 26 are disposed on the −Z direction side of the six magnets 25. The six second contacts 23 are arranged to correspond in position to the six first contacts 12 of the first connector 11.

As shown in FIG. 8, the second contact 23 is constituted of a so-called pogo pin and includes a barrel 23A extending in the Z direction and a plunger 23B disposed to be elastically movable forward and backward in the Z direction within the barrel 23A. More specifically, a spring member (not shown) is disposed inside the barrel 23A and imparts an elastic force acting in the −Z direction to the plunger 23B. The plunger 23B is provided at its −Z directional end with a second contact portion 23C of pin shape that faces in the −Z direction.

As shown in FIG. 9, the magnet 25 has the shape of a curved plate being curved in an XY plane and extending in the Z direction and is magnetized such that magnetic field lines act mainly in the +Y direction. The curved shape of the magnet 25 in an XY plane has a curvature that allows the curved shape to follow an outer peripheral portion of the tubular portion 15A of the first retention member 15 of the first connector 11.

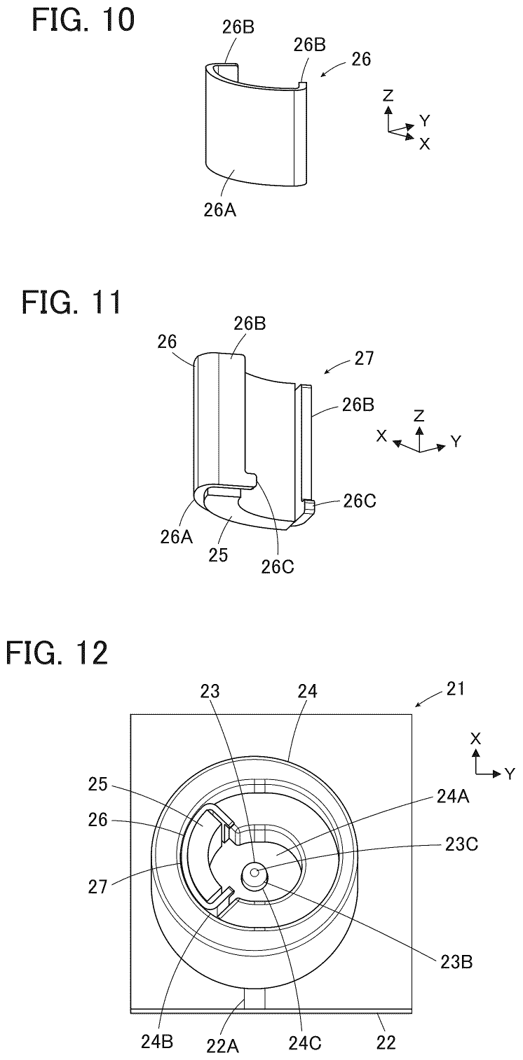

As shown in FIG. 10, the retention plate 26 is formed of a magnetic body and includes a curved portion 26A being curved in an XY plane and extending in the Z direction and a pair of flat portions 26B extending in the Z direction at the opposite ends of the curved shape of the curved portion 26A. The curved portion 26A is curved to follow an outer peripheral portion of the magnet 25, and the retention plate 26 has such a shape as to cover the curved surface facing in the −Y direction and the +X and −X directional lateral surfaces of the magnet 25.

As shown in FIG. 11, in the state where the magnet 25 is disposed on the inner side of the retention plate 26 and the curved surface facing in the −Y direction and the +X and −X directional lateral surfaces of the magnet 25 are covered with the retention plate 26, the retention plate 26 formed of a magnetic body is attracted by and attached to the magnet 25 by the magnetic force. The magnet 25 and the retention plate 26 as above together form a second retention member 27.

It should be noted that the −Z directional end of the magnet 25 protrudes in the −Z direction out of the −Z directional end of the retention plate 26.

The pair of flat portions 26B of the retention plate 26 are separately provided at their −Z directional ends with a pair of protrusion portions 26C protruding along the surfaces of the flat portions 26B on the +Y direction side. Specifically, the pair of protrusion portions 26C each protrude in a direction toward the center of the curved shape of the curved portion 26A. Each protrusion portion 26C has a height dimension in the Z direction slightly smaller than the width in the Z direction of the annular groove 15D of the first retention member 15 shown in FIG. 4 and therefore can be fitted in the annular groove 15D of the first retention member 15.

A lock receiving portion of the first connector 11 is formed by the annular groove 15D of the first retention member 15 shown in FIG. 4, and a lock portion of the second connector 21 is formed by the pair of protrusion portions 26C of the second retention member 27 shown in FIG. 11. The pair of protrusion portions 26C of the second retention member 27 are fitted in the annular groove 15D of the first retention member 15 along the Y direction (predetermined direction), thereby locking the fitting between the first connector 11 and the second connector 21.

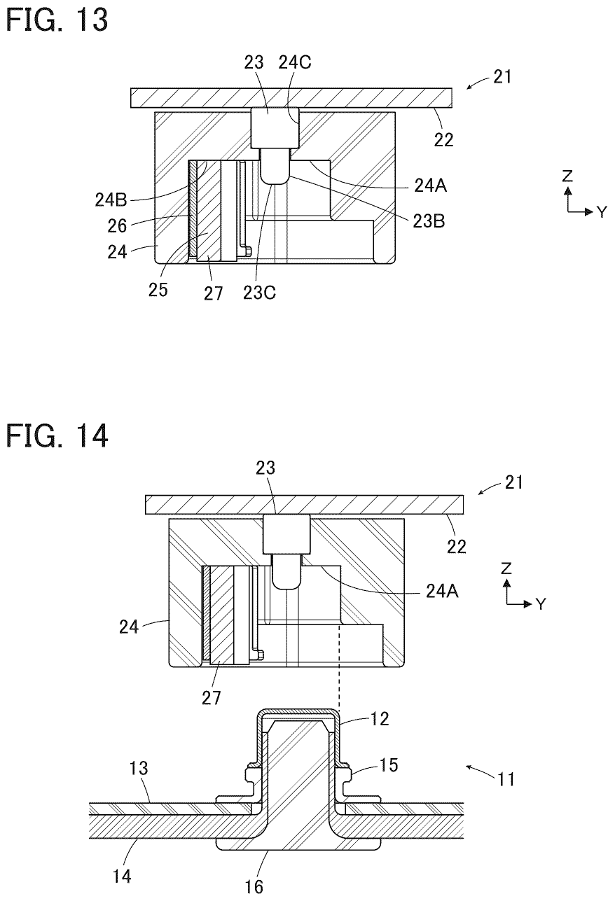

FIGS. 12 and 13 show a perspective view and a cross-sectional view corresponding to one second contact 23 of the second connector 21. The second insulator 24 is disposed on the −Z direction side of the substrate 22. The second insulator 24 has a cylindrical outer shape and is provided in its inside with a first contact accommodating portion 24A of recess shape that opens in the −Z direction and a second retention member accommodating portion 24B of recess shape that opens in the −Z direction. The first contact accommodating portion 24A and the second retention member accommodating portion 24B are disposed to be adjacent to each other and communicate with each other within the second insulator 24.

Specifically, the first contact accommodating portion 24A has an elliptical shape elongated in the Y direction (predetermined direction) when viewed from the −Z direction, and the second retention member accommodating portion 24B is disposed to be adjacent to the −Y directional end of the first contact accommodating portion 24A. Since the first contact accommodating portion 24A has an elliptical shape elongated in the Y direction, the second connector 21 is slidable in the Y direction (predetermined direction) with respect to the first connector 11 with the first contact 12 of the first connector 11 being accommodated in the first contact accommodating portion 24A from the −Z direction.

In addition, the bottom of the first contact accommodating portion 24A is provided with a second contact accommodating hole 24C that is situated on the central axis, which extends in the Z direction, of the second insulator 24 having a cylindrical outer shape and that penetrates the second insulator 24 in the Z direction.

A wiring portion 22A is formed on the rear surface of the substrate 22 on the −Z direction side as shown in FIG. 12. The second contact 23 is mounted on the substrate 22 so as to be connected to the wiring portion 22A and accommodated in the second contact accommodating hole 24C of the second insulator 24. As shown in FIGS. 12 and 13, the plunger 23B of the second contact 23 protrudes within the first contact accommodating portion 24A of the second insulator 24 through the second contact accommodating hole 24C, and the second contact portion 23C formed at the −Z directional end of the plunger 23B is exposed within the first contact accommodating portion 24A.

Each of the six second insulators 24 of the second connector 21 is disposed on the −Z direction side of the substrate 22, the second contact 23 is accommodated in the second contact accommodating hole 24C of the corresponding second insulator 24, and the second retention member 27 is accommodated in the second retention member accommodating portion 24B of the corresponding second insulator 24, as shown in FIG. 13. In the state where the retention plate 26 is bonded and fixed to the inner peripheral surface of the second retention member accommodating portion 24B of the second insulator 24 and the +Z directional end of the magnet 25 is bonded and fixed to the bottom, on the +Z direction side, of the second retention member accommodating portion 24B of the second insulator 24, the retention plate 26 formed of a magnetic body is attracted by and attached to the magnet 25 by the magnetic force.

It should be noted that the orientations of the six second insulators 24 in an XY plane are uniform; specifically, in each second insulator 24, the first contact accommodating portion 24A has an elliptical shape elongated in the Y direction, and the second retention member accommodating portion 24B is disposed to be adjacent to the −Y directional end of the first contact accommodating portion 24A.

To fit the second connector 21 to the first connector 11, as shown in FIG. 14, the second connector 21 is placed on the +Z direction side of the first connector 11, and the first connector 11 and the second connector 21 are positioned with respect to each other such that the +Y directional end of the first contact accommodating portion 24A of elliptical shape elongated in the Y direction of the second insulator 24 is aligned with the +Z direction side of the +Y directional end of the first contact 12.

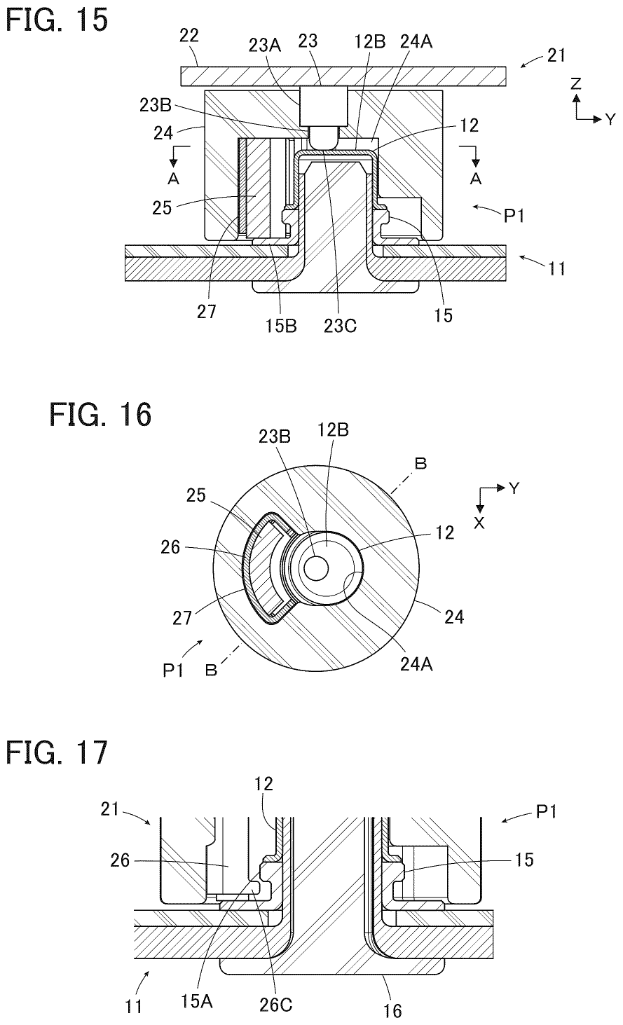

In this state, the second connector 21 is relatively moved in the −Z direction toward the first connector 11, whereby the first contact 12 of the first connector 11 is accommodated into the first contact accommodating portion 24A of the second insulator 24 of the second connector 21 as shown in FIG. 15.

When the second connector 21 is relatively moved in the −Z direction until the −Z directional end of the magnet 25 of the second retention member 27 of the second connector 21 abuts on the flange 15B of the first retention member 15 of the first connector 11, the second contact portion 23C formed on the plunger 23B of the second contact 23 of the second connector 21 makes contact with the first contact portion 12B in a flat shape of the first contact 12 of the first connector 11, so that a part of the plunger 23B is elastically retracted into the barrel 23A. The first contact portion 12B thus contacts the second contact portion 23C in the Z direction at a predetermined contact pressure, so that the first contact 12 and the second contact 23 are electrically connected together.

In addition, since the −Z directional end of the magnet 25 of the second retention member 27 abuts on the flange 15B of the first retention member 15 formed of a magnetic body, the magnet 25 is attracted by and attached to the flange 15B by the magnetic force, thus maintaining the contacting state between the first contact portion 12B and the second contact portion 23C in the Z direction.

The position of the second connector 21 with respect to the first connector 11 at this time is called a fitting start position P1.

Since the second connector 21 is relatively moved in the −Z direction with the +Y directional end of the first contact accommodating portion 24A of the second insulator 24 being aligned with the +Y directional end of the first contact 12 in the Z direction, the first contact 12 is accommodated in a position offset to the +Y direction side within the first contact accommodating portion 24A of elliptical shape elongated in the Y direction, as shown in FIG. 16. Thus, the plunger 23B of the second contact 23 is situated in an eccentric position with respect to the circular first contact portion 12B of the first contact 12. Accordingly, a gap is formed between the −Y directional end of the first contact 12 and the second retention member 27, so that the second connector 21 can be relatively moved in the −Z direction to the fitting start position P1 with no interference between the protrusion portion 26C, which protrudes on the +Y direction side from the −Z directional end of the retention plate 26 of the second retention member 27, and the first contact 12 or the tubular portion 15A of the first retention member 15, as shown in FIG. 17.

When the second connector 21 is in the fitting start position P1 as shown in FIGS. 15 to 17, the first contact 12 and the second contact 23 are electrically connected together because the first contact portion 12B contacts the second contact portion 23C in the Z direction at a predetermined contact pressure, and the second connector 21 is in the fitting start position P1 with respect to the first connector 11 only with the magnetic force acting between the magnet 25 of the second retention member 27 and the flange 15B of the first retention member 15.

Further, since the first contact 12 and the second contact 23 are connected together with the plunger 23B of the second contact 23 being elastically retracted, a force acting in the direction of separating the first connector 11 and the second connector 21 from each other in the Z direction is exerted from the second contact 23.

Therefore, if an external force due to, for instance, impact acts between the first connector 11 and the second connector 21 to move the second connector 21 in the +Z direction with respect to the first connector 11, the contact between the first contact 12 and the second contact 23 is destabilized, and this may lead to lower reliability of the electric connection.

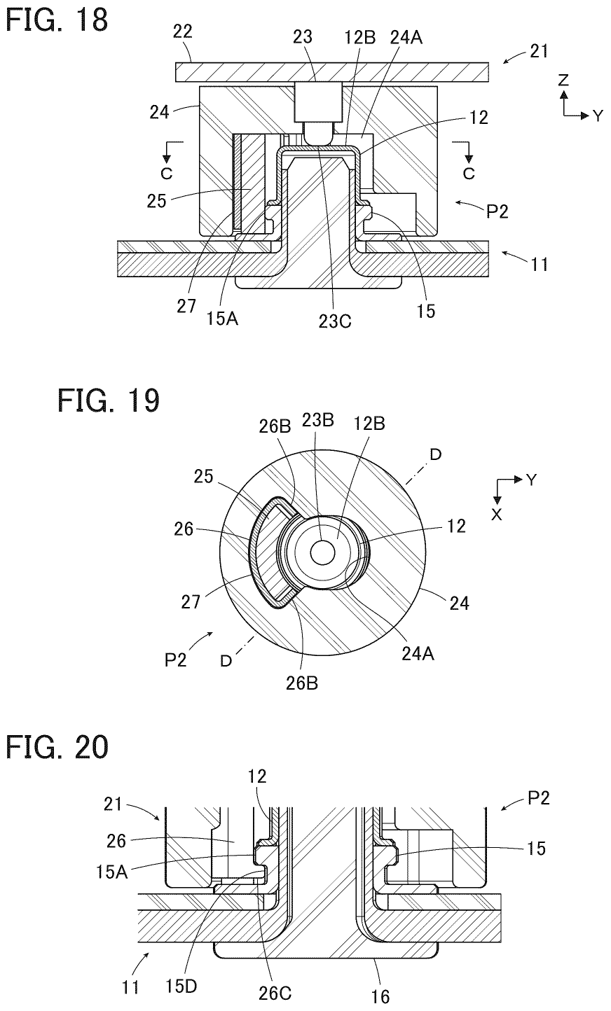

To cope with it, the second connector 21 is relatively slid in the +Y direction with respect to the first connector 11 until the second retention member 27 of the second connector 21 makes contact with or closely approaches the tubular portion 15A of the first retention member 15 of the first connector 11, as shown in FIG. 18. Specifically, the second connector 21 is slid with respect to the first connector 11 until the magnet 25 of the second retention member 27 makes contact with or closely approaches the −Y directional end of the tubular portion 15A of the first retention member 15.

At this time, since the first contact portion 12B of the first contact 12 of the first connector 11 has a flat shape extending along an XY plane, the second contact portion 23C of the second contact 23 slides in the +Y direction with respect to the first contact portion 12B while maintaining contact with the first contact portion 12B of the first contact 12. Thus, the electric connection between the first contact 12 and the second contact 23 is maintained.

Besides, even when dirt or foreign matter is attached to a surface of at least one of the first contact portion 12B of the first contact 12 or the second contact portion 23C of the second contact 23, sliding of the second contact portion 23C in the +Y direction with respect to the first contact portion 12B generates a wiping effect, and this effectively removes such dirt or foreign matter, thus improving contact stability between the first contact portion 12B and the second contact portion 23C.

When the second connector 21 is slid in the +Y direction with respect to the first connector 11, as shown in FIG. 19, the first contact 12 is positioned on the −Y direction side within the first contact accommodating portion 24A of elliptical shape elongated in the Y direction, so that the plunger 23B of the second contact 23 is situated in the center of the circular first contact portion 12B of the first contact 12.

In addition, the pair of protrusion portions 26C protruding on the +Y direction side from the −Z directional ends of the pair of flat portions 26B of the retention plate 26 of the second retention member 27 are fitted into the annular groove 15D formed in the tubular portion 15A of the first retention member 15, as shown in FIG. 20.

In other words, the lock portion formed by the pair of protrusion portions 26C is fitted in the lock receiving portion formed by the annular groove 15D, whereby the second connector 21 is prevented from moving in the +Z direction with respect to the first connector 11, thus maintaining the electrically connected state between the first contact 12 and the second contact 23 through the contact between the first contact portion 12B and the second contact portion 23C.

The second connector 21 is thus fitted to the first connector 11.

The position of the second connector 21 with respect to the first connector 11 at this time is called a fitting completed position P2.

Since the magnet 25 of the second retention member 27 makes contact with or closely approaches the −Y directional end of the tubular portion 15A of the first retention member 15, the magnetic force acts between the magnet 25 and the tubular portion 15A formed of a magnetic body to attract them to each other in the Y direction, and this keeps the second connector 21 in the fitting completed position P2 with respect to the first connector 11.

Owing to the second connector 21 being in the fitting completed position P2, the second contact 23 of the second connector 21 is electrically connected to the corresponding flexible conductor 14C of the sheet type conductive member 14 via the first contact 12 of the first connector 11.

Since the six second insulators 24 of the second connector 21 are disposed on the −Z direction side of the substrate 22 with their orientations being uniform in an XY plane, when the substrate 22 is relatively moved in the −Z direction toward the first connector 11, the state where the second connector 21 is in the fitting start position P1 with respect to the first connector 11 is formed in each of the six second insulators 24, and further, when the substrate 22 is relatively slid in the +Y direction with respect to the first connector 11, the state where the second connector 21 is in the fitting completed position P2 with respect to the first connector 11 is formed in each of the six second insulators 24.

Thus, the fitted state is established between the first connector 11 and the second connector 21 as shown in FIG. 21.

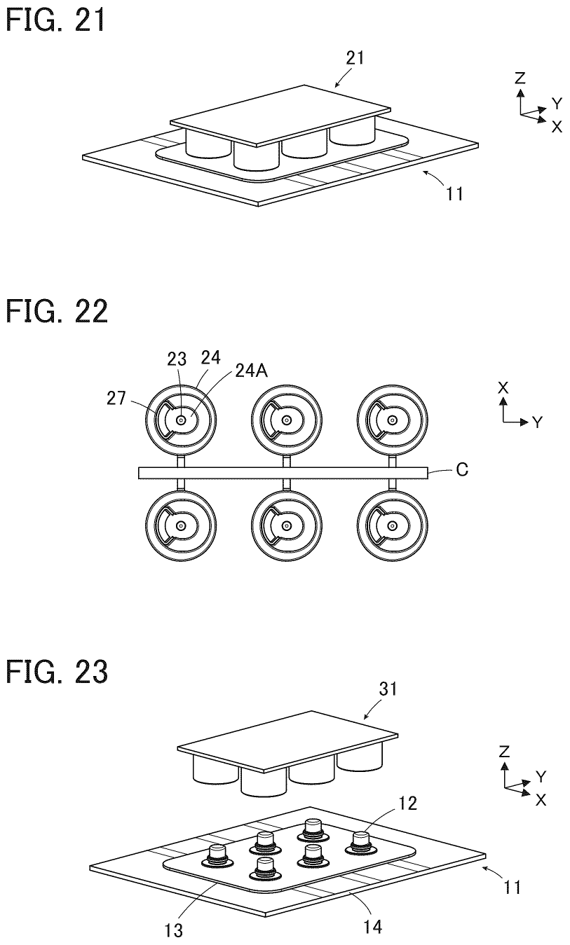

Since the six second insulators 24 of the second connector 21 need to be uniformly oriented in an XY plane, for instance, the six second insulators 24 may be formed by resin molding to be joined together via a joint member C as shown in FIG. 22. The six second insulators 24 are molded to be joined while keeping their positional relation that is required when disposed on the substrate 22, and the six second contacts 23 mounted on the substrate 22 are accommodated into the six second insulators 24 that are still joined, whereby the six second insulators 24 are disposed on the substrate 22. Subsequently, the second retention members 27 are accommodated into the corresponding second insulators 24.

Thereafter, the joint member C is cut and removed from the six second insulators 24. Thus, the second connector 21 can be fabricated with the second insulators 24 being in a uniform orientation.

### Embodiment 2

FIG. 23 shows a connector assembly according to Embodiment 2. The connector assembly is configured such that in the connector assembly according to Embodiment 1, a first connector 11 is fitted to a second connector 31 in place of the second connector 21, and the first connector 11 is the same as that used in Embodiment 1.

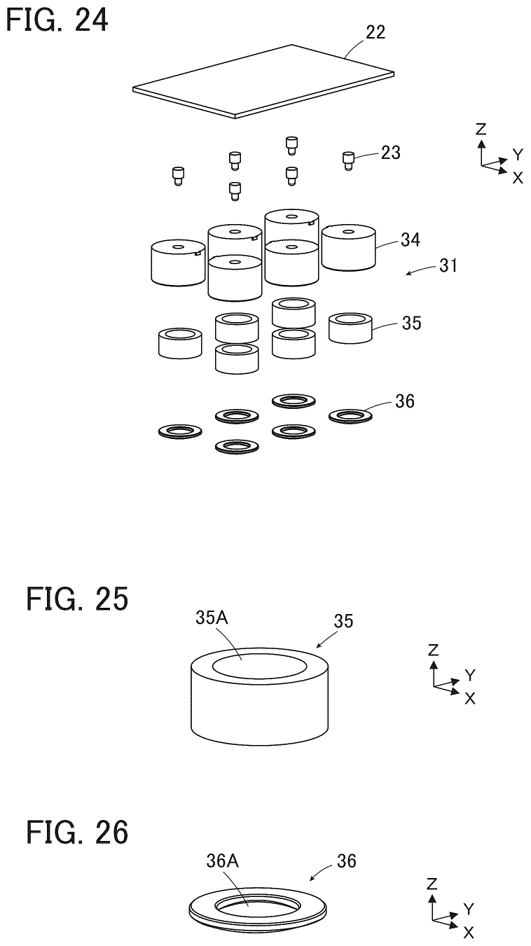

FIG. 24 shows an assembly view of the second connector 31. Six second contacts 23 are disposed on the −Z direction side of a substrate 22, six second insulators 34 are disposed on the −Z direction side of the six second contacts 23, six magnets 35 are disposed on the −Z direction side of the six second insulators 34, and six retention plates 36 are disposed on the −Z direction side of the six magnets 35.

The substrate 22 and the six second contacts 23 are the same as those used in Embodiment 1.

As shown in FIG. 25, the magnet 35 has a cylindrical shape extending in the Z direction and is provided in its inside with a through-hole 35A that penetrates the magnet 35 in the Z direction. The magnet 35 is magnetized such that magnetic field lines act mainly in the +Y direction.

As shown in FIG. 26, the retention plate 36 is formed of a magnetic body and constituted of a ring member extending in a flat plate form along an XY plane. The retention plate 36 is provided with a through-hole 36A that penetrates the retention plate 36 in the Z direction.

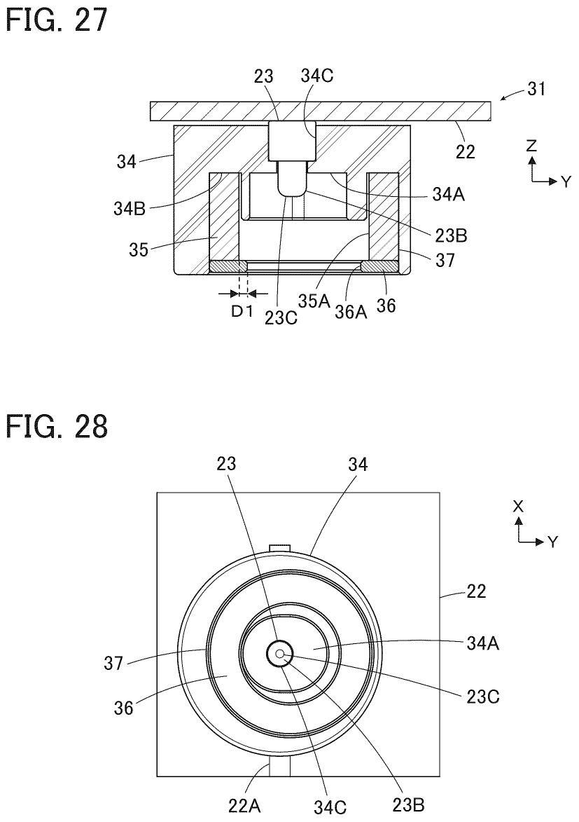

FIG. 27 shows a cross-sectional view corresponding to one second contact 23 of the second connector 31. The second insulator 34 is disposed on the −Z direction side of the substrate 22. The second insulator 34 has a cylindrical outer shape and is provided in its inside with a first contact accommodating portion 34A of recess shape that opens in the −Z direction and a second retention member accommodating portion 34B of recess shape that opens in the −Z direction. The second retention member accommodating portion 34B is situated outside the first contact accommodating portion 34A to surround the first contact accommodating portion 34A and communicates with the first contact accommodating portion 34A.

The bottom of the first contact accommodating portion 34A is provided with a second contact accommodating hole 34C that is situated on the central axis, which extends in the Z direction, of the second insulator 34 having a cylindrical outer shape and that penetrates the second insulator 34 in the Z direction.

The second contact 23 mounted on the substrate 22 is accommodated in the second contact accommodating hole 34C of the second insulator 34, the plunger 23B of the second contact 23 protrudes within the first contact accommodating portion 34A of the second insulator 34 through the second contact accommodating hole 34C, and the second contact portion 23C formed at the −Z directional end of the plunger 23B is exposed within the first contact accommodating portion 34A.

The cylindrical magnet 35 is accommodated in the second retention member accommodating portion 34B of the second insulator 34. In addition, the retention plate 36 constituted of a ring member formed of a magnetic body is press-fitted or bonded and thereby fixed to the −Z directional open end of the second retention member accommodating portion 34B of the second insulator 34, and attracted by and attached to the −Z directional end of the magnet 35 by the magnetic force. The magnet 35 and the retention plate 36 as above together form a second retention member 37.

The retention plate 36 constituted of a ring member has the same outer diameter as the outer diameter of the cylindrical magnet 35, and the through-hole 36A of the retention plate 36 has an inner diameter smaller than the inner diameter of the through-hole 35A of the magnet 35, so that a step D1 is formed between the inner surface of the through-hole 36A of the retention plate 36 and the inner surface of the through-hole 35A of the magnet 35, and an edge portion of the through-hole 36A of the retention plate 36 protrudes inside the through-hole 35A of the magnet 35, as shown in FIG. 27. The retention plate 36 has a thickness in the Z direction slightly smaller than the width in the Z direction of the annular groove 15D of the first retention member 15 shown in FIG. 4, so that the edge portion of the through-hole 36A of the retention plate 36 that protrudes inside the through-hole 35A of the magnet 35 can be fitted in the annular groove 15D of the first retention member 15.

The through-hole 36A of the retention plate 36 is sized to allow the first contact 12 and the tubular portion 15A of the first retention member 15 to pass therethrough in the Z direction.

As shown in FIG. 28, the first contact accommodating portion 34A has an elliptical shape elongated in the Y direction (predetermined direction) when viewed from the −Z direction. Accordingly, the second connector 31 is slidable in the Y direction (predetermined direction) with respect to the first connector 11 with the first contact 12 of the first connector 11 being accommodated in the first contact accommodating portion 34A from the −Z direction.

The second retention member 37 is situated in an eccentric position in the +Y direction with respect to the second insulator 34 having a cylindrical outer shape.

Each of the six second insulators 34 of the second connector 31 is disposed on the −Z direction side of the substrate 22, the second contact 23 is accommodated in the second contact accommodating hole 34C of the corresponding second insulator 34, and the second retention member 37 is accommodated in the second retention member accommodating portion 34B of the corresponding second insulator 34, as shown in FIG. 27.

It should be noted that the orientations of the six second insulators 34 in an XY plane are uniform, and in each second insulator 34, the first contact accommodating portion 34A has an elliptical shape elongated in the Y direction as shown in FIG. 28.

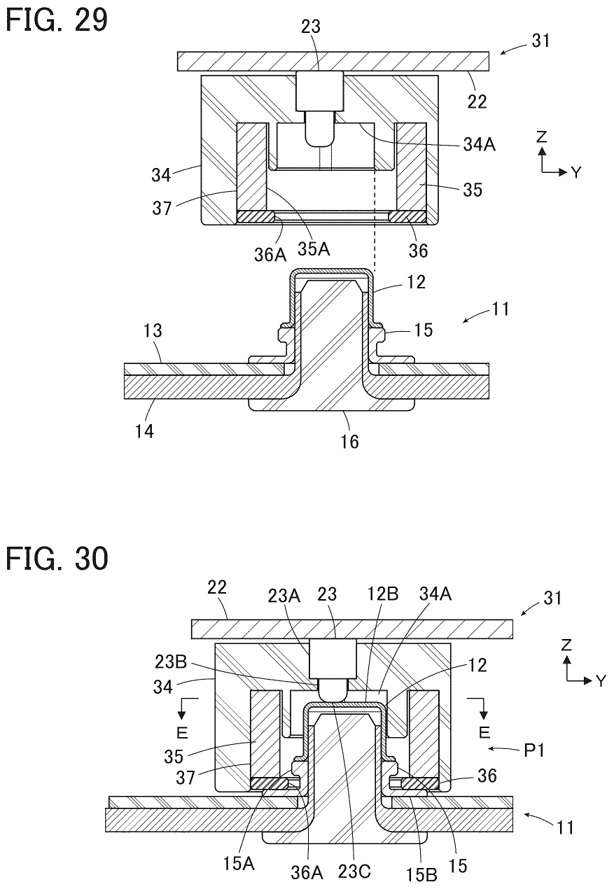

To fit the second connector 31 to the first connector 11, as shown in FIG. 29, the second connector 31 is placed on the +Z direction side of the first connector 11, and the first connector 11 and the second connector 31 are positioned with respect to each other such that the +Y directional end of the first contact accommodating portion 34A of elliptical shape elongated in the Y direction of the second insulator 34 is aligned with the +Z direction side of the +Y directional end of the first contact 12.

In this state, the second connector 31 is relatively moved in the −Z direction toward the first connector 11, whereby the first contact 12 of the first connector 11 is accommodated into the first contact accommodating portion 34A of the second insulator 34 of the second connector 31 as shown in FIG. 30.

When the second connector 31 is relatively moved in the −Z direction until the retention plate 36 of the second retention member 37 of the second connector 31 abuts on the flange 15B of the first retention member 15 of the first connector 11, the second contact portion 23C formed on the plunger 23B of the second contact 23 of the second connector 31 makes contact with the first contact portion 12B in a flat shape of the first contact 12 of the first connector 11, so that a part of the plunger 23B is elastically retracted into the barrel 23A. The first contact portion 12B thus contacts the second contact portion 23C in the Z direction at a predetermined contact pressure, so that the first contact 12 and the second contact 23 are electrically connected together.

In addition, since the retention plate 36 disposed on the −Z directional end of the magnet 35 of the second retention member 37 abuts on the flange 15B of the first retention member 15 formed of a magnetic body, the magnet 35 is attracted by and attached to the flange 15B by the magnetic force via the retention plate 36, thus maintaining the contacting state between the first contact portion 12B and the second contact portion 23C in the Z direction.

The position of the second connector 31 with respect to the first connector 11 at this time is called a fitting start position P1.

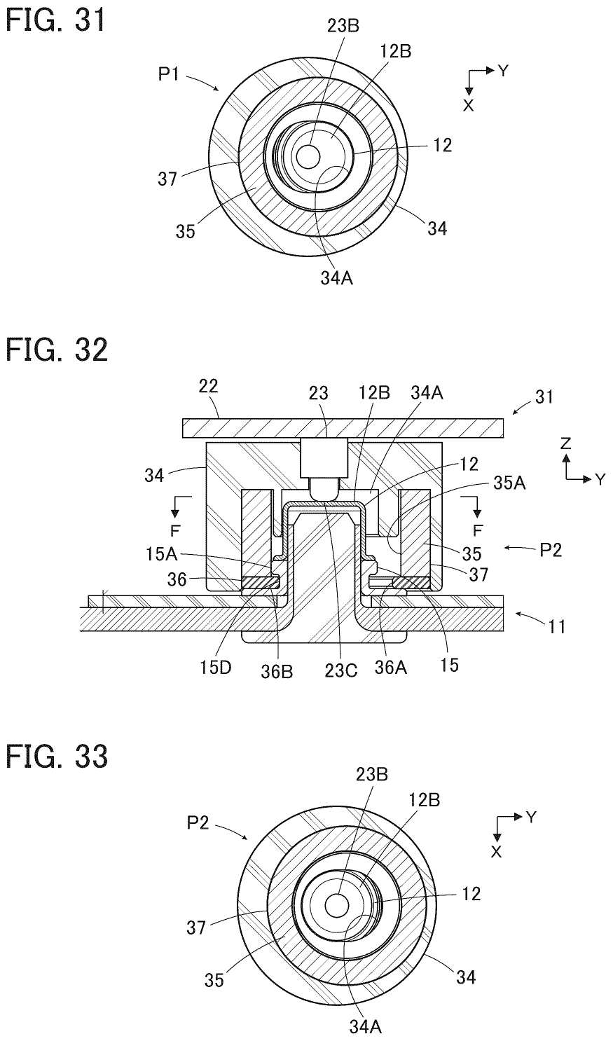

Since the second connector 31 is relatively moved in the −Z direction with the +Y directional end of the first contact accommodating portion 34A of the second insulator 34 being aligned with the +Y directional end of the first contact 12 in the Z direction, the first contact 12 is accommodated in a position offset to the +Y direction side within the first contact accommodating portion 34A of elliptical shape elongated in the Y direction as shown in FIG. 31.

Accordingly, a gap is formed between the −Y directional end of the first contact 12 and the −Y directional end of the interior of the first contact accommodating portion 34A, so that the second connector 31 can be relatively moved in the −Z direction to the fitting start position P1 with no interference between the edge portion of the through-hole 36A of the retention plate 36 of the second retention member 37 and the first contact 12 or the tubular portion 15A of the first retention member 15 as shown in FIG. 30.

When the second connector 31 is in the fitting start position P1 as shown in FIG. 30, the first contact 12 and the second contact 23 are electrically connected together because the first contact portion 12B contacts the second contact portion 23C in the Z direction at a predetermined contact pressure, and the second connector 31 is in the fitting start position P1 with respect to the first connector 11 only with the magnetic force acting between the magnet 35 of the second retention member 37 and the flange 15B of the first retention member 15.

Further, since the first contact 12 and the second contact 23 are connected together with the plunger 23B of the second contact 23 being elastically retracted, a force acting in the direction of separating the first connector 11 and the second connector 31 from each other in the Z direction is exerted from the second contact 23.

Therefore, if an external force due to, for instance, impact acts between the first connector 11 and the second connector 31 to move the second connector 31 in the +Z direction with respect to the first connector 11, the contact between the first contact 12 and the second contact 23 is destabilized, and this may lead to lower reliability of the electric connection.

To cope with it, the second connector 31 is relatively slid in the +Y direction with respect to the first connector 11 until the second retention member 37 of the second connector 31 makes contact with or closely approaches the tubular portion 15A of the first retention member 15 of the first connector 11, as shown in FIG. 32. Specifically, the second connector 31 is slid with respect to the first connector 11 until the inner surface of the magnet 35 of the second retention member 37 makes contact with or closely approaches the −Y directional end of the tubular portion 15A of the first retention member 15.

At this time, since the first contact portion 12B of the first contact 12 of the first connector 11 has a flat shape extending along an XY plane, the second contact portion 23C of the second contact 23 slides in the +Y direction with respect to the first contact portion 12B while maintaining contact with the first contact portion 12B of the first contact 12. Thus, the electric connection between the first contact 12 and the second contact 23 is maintained.

In addition, a wiping effect is generated also in Embodiment 2 due to sliding of the second contact portion 23C in the +Y direction with respect to the first contact portion 12B; therefore, even when dirt or foreign matter is attached to a surface of at least one of the first contact portion 12B of the first contact 12 or the second contact portion 23C of the second contact 23, such dirt or foreign matter is effectively removed, thus improving contact stability between the first contact portion 12B and the second contact portion 23C.

When the second connector 31 is slid in the +Y direction with respect to the first connector 11, the first contact 12 is positioned on the −Y direction side within the first contact accommodating portion 34A of elliptical shape elongated in the Y direction as shown in FIG. 33, and an edge portion 36B at the −Y directional end of the through-hole 36A of the retention plate 36 that protrudes inside the through-hole 35A of the magnet 35 of the second retention member 37 is fitted into the annular groove 15D formed in the tubular portion 15A of the first retention member 15 as shown in FIG. 32.

The edge portion 36B at the −Y directional end of the through-hole 36A of the retention plate 36 forms a lock portion in the second connector 31. When this lock portion is fitted in the lock receiving portion, which is formed by the annular groove 15D, of the first connector 11 along the Y direction (predetermined direction), the second connector 31 is prevented from moving in the +Z direction with respect to the first connector 11, thus maintaining the electrically connected state between the first contact 12 and the second contact 23 through the contact between the first contact portion 12B and the second contact portion 23C.

The second connector 31 is thus fitted to the first connector 11.

The position of the second connector 31 with respect to the first connector 11 at this time is called a fitting completed position P2.

In addition, since the inner surface of the magnet 35 of the second retention member 37 makes contact with or closely approaches the −Y directional end of the tubular portion 15A of the first retention member 15, the magnetic force acts between the magnet 35 and the tubular portion 15A formed of a magnetic body to attract them to each other in the Y direction, and this keeps the second connector 31 in the fitting completed position P2 with respect to the first connector 11.

Since the six second insulators 34 of the second connector 31 are disposed on the −Z direction side of the substrate 22 with their orientations being uniform in an XY plane, when the substrate 22 is relatively moved in the −Z direction toward the first connector 11, the state where the second connector 31 is in the fitting start position P1 with respect to the first connector 11 is formed in each of the six second insulators 34, and further, when the substrate 22 is relatively slid in the +Y direction with respect to the first connector 11, the state where the second connector 31 is in the fitting completed position P2 with respect to the first connector 11 is formed in each of the six second insulators 34.

Thus, the fitted state is established between the first connector 11 and the second connector 31.

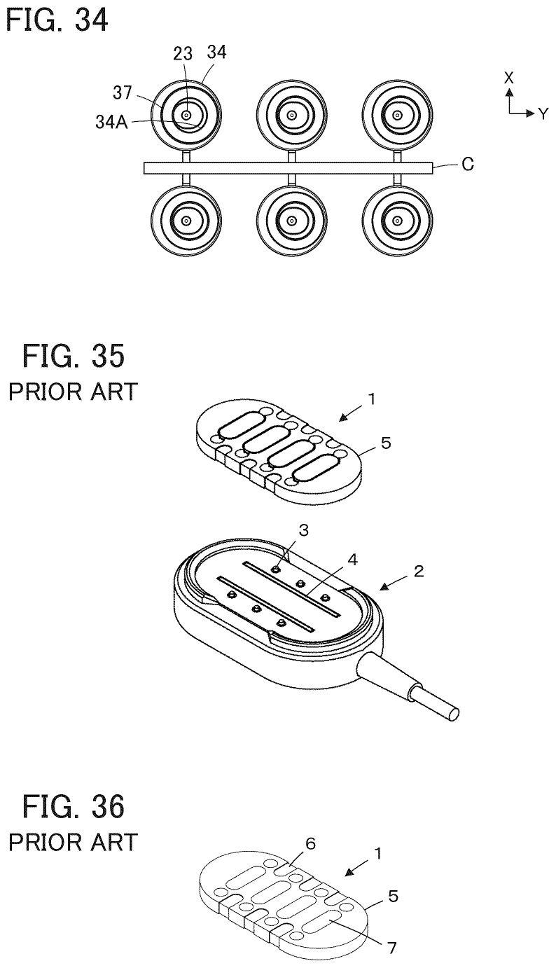

Since the six second insulators 34 of the second connector 31 need to be uniformly oriented in an XY plane, for instance, the six second insulators 34 may be formed by resin molding to be joined together via a joint member C as shown in FIG. 34. The six second insulators 34 are molded to be joined while keeping their positional relation that is required when disposed on the substrate 22, and the six second contacts 23 mounted on the substrate 22 are accommodated into the six second insulators 34 that are still joined, whereby the six second insulators 34 are disposed on the substrate 22. Subsequently, the second retention members 37 are accommodated into the corresponding second insulators 34.

Thereafter, the joint member C is cut and removed from the six second insulators 34. Thus, the second connector 31 can be fabricated with the second insulators 34 being in a uniform orientation.

The first contact 12 of the first connector 11 used in Embodiments 1 and 2 has a cylindrical shape extending in the Z direction, is connected to the flexible conductor 14C of the sheet type conductive member 14 inside the recess portion 12A formed therein, and is coaxially stacked on the first retention member 15 in the Z direction, the first retention member 15 being provided with the annular groove 15D serving as the lock receiving portion. This configuration makes it possible to arrange each first contact 12 in a small space in an XY plane while forming the lock receiving portion for each first contact 12.

The present invention is not configured such that the connection state between the plurality of first contacts 12 and the plurality of second contacts 23 is maintained by one set of the lock portion and the lock receiving portion, but configured such that the first retention member 15 having the lock receiving portion and the second retention member 27 or 37 having the lock portion are provided for each set of the first contact 12 and the second contact 23 connected together. This configuration can prevent such defects as locking the fitting between the first connector 11 and the second connector 21 or 31 in the state where foreign matter is stuck between, of a plurality of the first contacts 12 and a plurality of the second contacts 23, a part of the first and second contacts 12 and 23; thus, the plurality of the first contacts 12 and the plurality of the second contacts 23 can be reliably connected together.

It should be noted that the six first contacts 12 of the first connector 11 are attached to the sheet type conductive member 14 via the reinforcement sheet 13, and the six first insulators 16 corresponding to the six first contacts 12 are separate from one another. Accordingly, the first connector 11 has flexibility, and when cloth or knitted fabric of a garment is used as the sheet body 14A for instance, the first connector 11 can be attached to the garment without a decrease in wearing comfort.

Besides, while a circuit board having rigidity can be used as the substrate 22 in the second connector 21 or 31, a so-called flexible printed circuit (FPC) having an insulating film can also be used as the substrate 22. In the second connector 21, 31, since the six second insulators 24, 34 are disposed on the substrate 22 in the state of being separate from one another, the use of an FPC as the substrate 22 allows the second connector 21, 31 to have flexibility. When the flexible second connector 21, 31 as above is fitted to the first connector 11, the connector assembly that is bendable even after fitting can be formed, and this is suitable as a connector assembly for connecting a wearable device to so-called smart clothes that can acquire user's biological data such as the heart rate and the body temperature only by being worn by the user.

In Embodiments 1 and 2 above, the first contact portion 12B of the first contact 12 has a flat shape extending along an XY plane, and the second contact portion 23C of the second contact 23 has a pin shape; however, even when the first contact portion 12B of the first contact 12 has a pin shape and the second contact portion 23C of the second contact 23 has a flat shape extending along an XY plane in an opposite fashion, the same effect can be obtained.

In Embodiments 1 and 2 above, the first retention member 15 of the first connector 11 has the lock receiving portion (the annular groove 15D), and the second retention member 27, 37 of the second connector 21, 31 has the lock portion (the protrusion portion 26C, the edge portion 36B of the through-hole 36A of the retention plate 36) protruding in the Y direction; however, even when the first retention member 15 of the first connector 11 has the lock portion and the second retention member 27, 37 of the second connector 21, 31 has the lock receiving portion in an opposite fashion, the same effect can be obtained.

In Embodiments 1 and 2 above, the first connector 11 has the six first contacts 12, and the second connector 21, 31 has the six second contacts 23; however, the numbers of the first contacts 12 and the second contacts 23 are each not limited to six, and it is sufficient that at least one first contact 12 and at least one second contact 23 are disposed in the first connector 11 and the second connector 21, 31, respectively.

What is claimed is:

1. A connector assembly in which a first connector and a second connector are fitted together along a fitting direction,
the first connector including:
a first contact having electrical conductivity and having a first contact portion; and
a first retention member joined to the first contact, and
the second connector including:
a second insulator;
a second contact having electrical conductivity, retained by the second insulator, and having a second contact portion that faces the first contact portion of the first contact along the fitting direction; and
a second retention member retained by the second insulator, the second retention member attracting and being attracted to the first retention member by a magnetic force,
wherein one of the first contact portion and the second contact portion has a flat shape extending in a predetermined direction perpendicular to the fitting direction,
one of the first retention member and the second retention member has a lock portion, and the other thereof has a lock receiving portion into which the lock portion is fitted from the predetermined direction,
when the second connector is relatively moved to a predetermined fitting start position with respect to the first connector along the fitting direction, the second retention member is attracted to the first retention member along the fitting direction, and the second contact portion makes contact with the first contact portion, whereby the second contact is electrically connected to the first contact, and
when the second connector is relatively slid from the predetermined fitting start position to a predetermined fitting completed position with respect to the first connector along the predetermined direction, the second contact portion is relatively slid with respect to the first contact portion in the predetermined direction while maintaining contact with the first contact portion, and the lock portion is fitted into the lock receiving portion, whereby the second connector is fitted to the first connector.

2. The connector assembly according to claim 1,
wherein the first connector includes a first insulator having a projection projecting in the fitting direction,
the first contact has a tubular shape extending along the fitting direction and having a recess portion in its inside, and is provided with the first contact portion having the flat shape at one end of the first contact on a side closer to the second contact along the fitting direction,
the first retention member is disposed on a side of the other end of the first contact along the fitting direction and has a through-hole penetrating the first retention member in the fitting direction, and
the projection of the first insulator is sequentially inserted into the through-hole of the first retention member and the recess portion of the first contact while pushing, into the through-hole and the recess portion, a sheet type connection object having a flexible conductor exposed at least on a surface of the sheet type connection object, whereby the first contact is electrically connected to the flexible conductor, and also the first retention member is joined to the first contact.

3. The connector assembly according to claim 2,
wherein the first retention member is formed of a magnetic body and includes: a tubular portion extending along the fitting direction and provided with the through-hole; and a flange extending in the predetermined direction from an end of the tubular portion on an opposite side from the first contact, and
when the second connector is in the predetermined fitting start position, the second retention member is attracted to the flange of the first retention member along the fitting direction.

4. The connector assembly according to claim 3,
wherein when the second connector is relatively slid from the predetermined fitting start position to the predetermined fitting completed position with respect to the first connector along the predetermined direction, the second retention member is attracted to an outer lateral surface of the tubular portion of the first retention member along the predetermined direction.

5. The connector assembly according to claim 3,
wherein the first retention member includes an annular groove formed along an outer periphery of the tubular portion, and
the annular groove forms the lock receiving portion.

6. The connector assembly according to claim 3,
wherein the second retention member includes a magnet and a retention plate that is formed of a magnetic body and that is attracted by and attached to the magnet.

7. The connector assembly according to claim 6,
wherein the magnet has a shape of a curved plate that is curved to follow an outer peripheral portion of the tubular portion of the first retention member and that extends in the fitting direction,
the retention plate includes a curved portion that is curved to follow an outer peripheral portion of the magnet, a pair of flat portions extending in the fitting direction separately at opposite ends of a curved shape of the curved portion, and a pair of protrusion portions protruding in the predetermined direction separately from one ends of the pair of flat portions on a side closer to the first connector along the fitting direction, and
the pair of protrusion portions form the lock portion.

8. The connector assembly according to claim 6,
wherein the magnet has a cylindrical shape which extends in the fitting direction and in which the tubular portion of the first retention member is inserted,
the retention plate is constituted of a ring member disposed at one end of the magnet on a side closer to the first connector along the fitting direction and having an inner diameter smaller than an inner diameter of the magnet, and includes an overhanging portion protruding in the predetermined direction toward a central axis of the magnet of the cylindrical shape, and
the overhanging portion forms the lock portion.

9. The connector assembly according to claim 1,
the second insulator including:
a second retention member accommodating portion of recess shape in which the second retention member is accommodated; and
a first contact accommodating portion of recess shape in which at least a part of the first contact is accommodated,
wherein the second retention member accommodating portion and the first contact accommodating portion communicate with each other and open in the fitting direction toward the first connector, and
the second contact is retained by the second insulator such that at least a part of the second contact protrudes in the first contact accommodating portion.

10. The connector assembly according to claim 9,
wherein the second contact has a plunger disposed to be elastically movable forward and backward along the fitting direction, and the second contact portion disposed at a tip of the plunger protrudes in the first contact accommodating portion.

11. The connector assembly according to claim 9,
wherein the first contact accommodating portion has an elliptical shape elongated in the predetermined direction as viewed from the fitting direction, and
when the second connector is in the predetermined fitting start position, the first contact is situated at one end of the first contact accommodating portion in the predetermined direction, and when the second connector is in the predetermined fitting completed position, the first contact is situated at the other end of the first contact accommodating portion in the predetermined direction.

12. The connector assembly according to claim 1,
wherein the first connector includes a plurality of the first contacts and a plurality of the first retention members corresponding to the plurality of the first contacts,
the second connector includes a plurality of the second insulators, a plurality of the second contacts retained separately by the plurality of the second insulators, and a plurality of the second retention members retained separately by the plurality of the second insulators and corresponding to the plurality of the second contacts,
one of either the plurality of the first retention members or the plurality of the second retention members has a plurality of the lock portions, and the other of either the plurality of the first retention members or the plurality of the second retention members has a plurality of the lock receiving portions, and
when the second connector is in the predetermined fitting completed position and fitted to the first connector, the plurality of the second contacts are separately electrically connected to the plurality of the first contacts, and the plurality of the lock portions are separately fitted into the plurality of the lock receiving portions.
